(19) United States
(12) Patent Application Publication
(10) Pub. No.: US 2011/0235011 A1
(43) Pub. Date: Sep. 29, 2011

(54) EXPOSURE DEVICE, SIGNAL TRANSMISSION MECHANISM FOR THE EXPOSURE DEVICE, AND IMAGE FORMING APPARATUS

(75) Inventor: Tatsuya HATORI, Kanagawa (JP)

(73) Assignee: FUJI XEROX CO., LTD., Tokyo (JP)

(21) Appl. No.: 12/942,555

(22) Filed: Nov. 9, 2010

(30) Foreign Application Priority Data
Mar. 26, 2010 (JP) 2010-073360

(51) Int. Cl. G03B 27/54

(52) U.S. Cl. 355/67

(57) ABSTRACT

An exposure device includes a substrate, an optical component, and a receiving section. The substrate has exposure light-emitting elements disposed thereon in a row. The optical component is formed integrally with the substrate, is provided with graded index lenses, and causes exposure light emitted from the exposure light-emitting elements to be focused on an exposure member to be exposed. The receiving section is provided at the substrate, receives an optical signal through the graded index lenses and, converts the received optical signal into an electrical signal. The optical signal is emitted from a light-emitting section provided at a side of the exposure member to be exposed.

### CROSS-REFERENCE TO RELATED APPLICATIONS

This application is based on and claims priority under 35 USC 119 from Japanese Patent Application No. 2010-073360 filed Mar. 26, 2010.

### BACKGROUND

### Technical Field

The present invention relates to an exposure device, a signal transmission mechanism for the exposure device, and an image forming apparatus.

### SUMMARY

According to an aspect of the invention, there is provided an exposure device including a substrate, an optical component, and a receiving section. The substrate has exposure light-emitting elements disposed thereon in a row. The optical component is formed integrally with the substrate, is provided with graded index lenses, and causes exposure light emitted from the exposure light-emitting elements to be focused on an exposure member to be exposed. The receiving section is provided at the substrate, receives an optical signal through the graded index lenses and, converts the received optical signal into an electrical signal. The optical signal is emitted from a light-emitting section provided at a side of the exposure member to be exposed.

### BRIEF DESCRIPTION OF THE DRAWINGS

Exemplary embodiments of the present invention will be described in detail based on the following figures, wherein:

FIG. 1 is a schematic view of the entire structure of an image forming apparatus according to an exemplary embodiment of the present invention;

FIG. 2 is a perspective view of an exposure device according to an exemplary embodiment of the present invention;

FIG. 3 is a schematic sectional view of the structure of the exposure device taken along line III-III shown in FIGS. 2 and 7;

FIG. 4 is a schematic sectional view of the exposure device and a signal transmission mechanism taken along line IV-IV shown in FIGS. 2 and 7;

FIG. 5A is a schematic perspective view of the structure of the signal transmission mechanism and the exposure device according to the exemplary embodiment of the present invention;

FIG. 5B is a schematic plan view of light-emitting-element chips;

FIG. 6 is an enlarged partial sectional side view of a bearing of a photoconductor member of the image forming apparatus according to the exemplary embodiment of the present invention;

FIG. 7 is a schematic perspective view of the structure of the signal transmission mechanism and the exposure device according to the exemplary embodiment of the present invention;

FIG. 8 is a block diagram illustrating the signal transmission mechanism and the exposure device according to the exemplary embodiment of the present invention; and

FIG. 9 is a schematic perspective view of the structure of a signal transmission mechanism and an exposure device according to another exemplary embodiment of the present invention.

### DETAILED DESCRIPTION

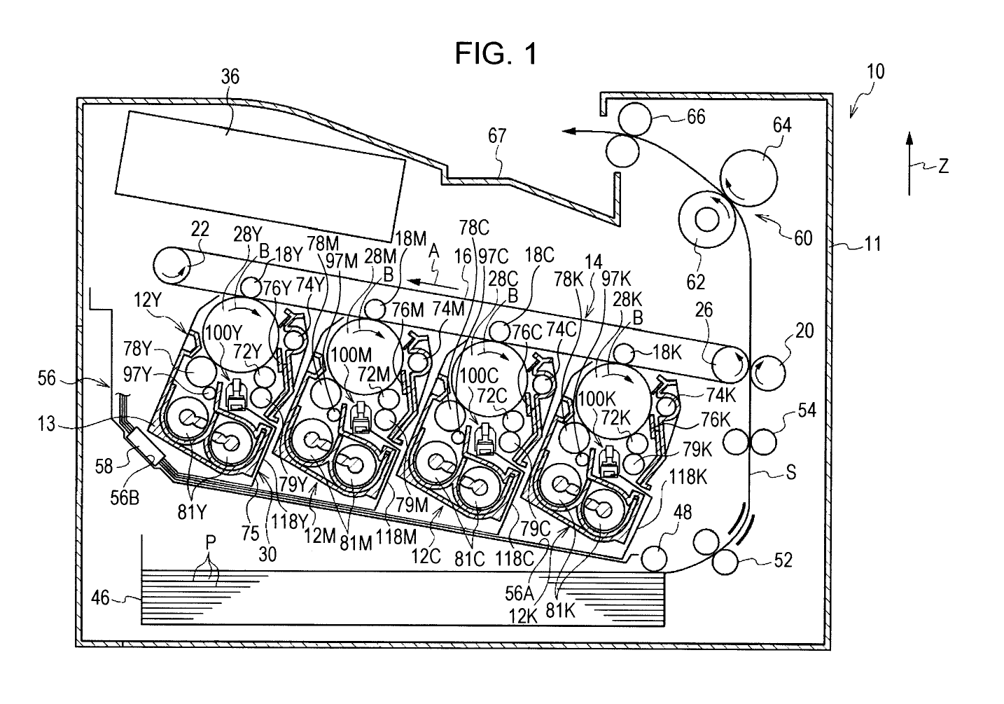

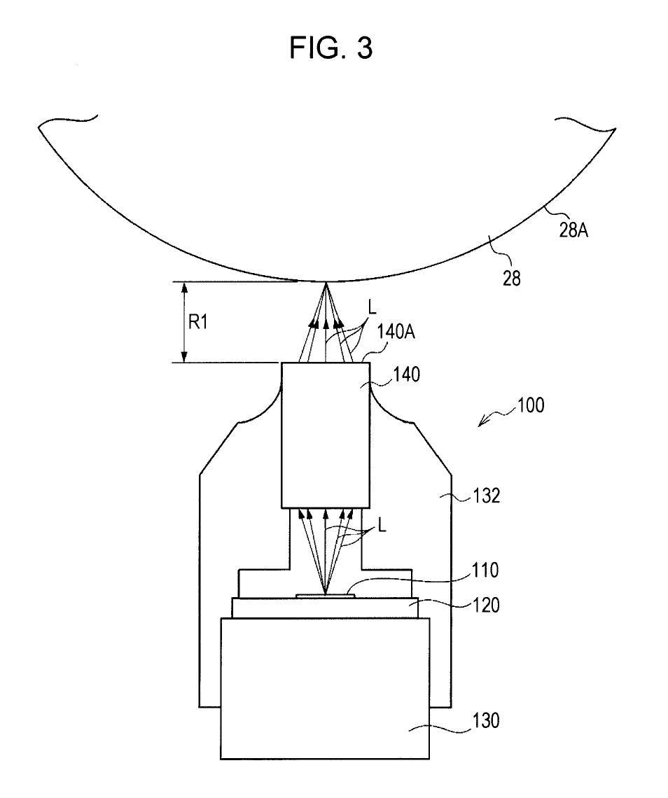

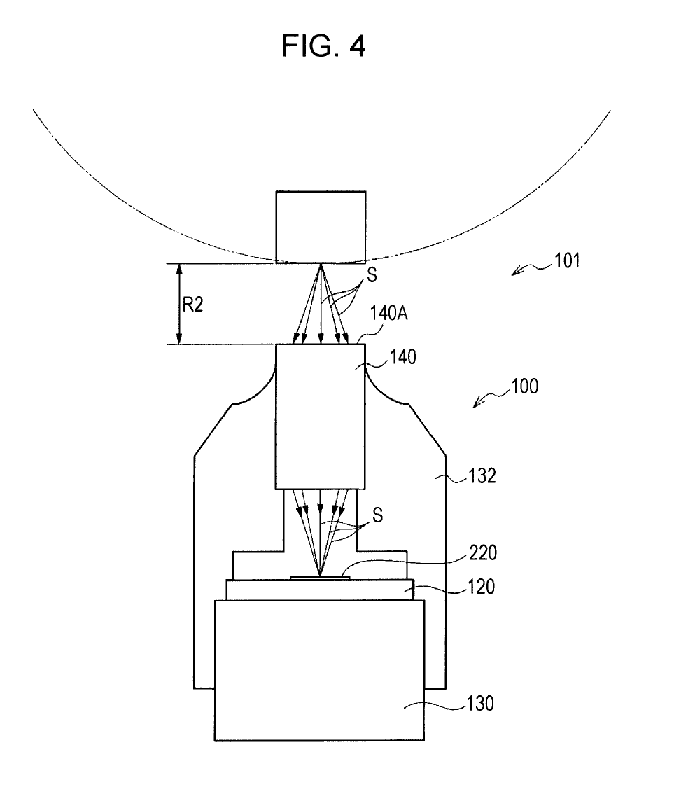

With reference to FIGS. 1 to 8, an exposure device and an image forming apparatus according to exemplary embodiments of the present invention will be described. FIGS. 3 and 4 are sectional views in a direction orthogonal to a longitudinal direction of the exposure device. However, for the sake of simplicity, FIGS. 3 and 4 are not provided with hatches that indicate the cross sections.

FIG. 1 shows an image forming apparatus 10 according to an exemplary embodiment of the present invention. The image forming apparatus 10 includes, for example, an image forming unit 12Y, an image forming unit 12M, an image forming unit 12C, and an image forming unit 12K that form images using toners (developers) of four colors, that is, the yellow (Y) toner, the magenta (M) toner, the cyan (C) toner, and the black (K) toner, respectively. The image forming units 12Y, 12M, 12C, and 12K are arranged side by side in an oblique direction (that is, in a rightward and downward direction in FIG. 1) in an apparatus body 11. In the exemplary embodiment, the image forming unit 12Y, the image forming unit 12M, the image forming unit 12C, and the image forming unit 12K are disposed in that order from the illustrated upper left to the illustrated lower right.

The image forming units 12Y, 12M, 12C, and 12K have the same structures, but contain different types of toners. In the description below, when the colors, yellow, magenta, cyan, and black need to be distinguished, the alphabets Y, M, C, and K will be added to the numbers that denote the image forming units. If the colors do not need to be distinguished, the alphabets Y, M, C, and K after the numbers that denote the image forming units will be omitted.

A transfer unit 14 that transfers toner images, formed on the respective image forming units 12Y, 12M, 12C, and 12K, to recording paper is provided above the image forming units 12Y, 12M, 12C, and 12K. The transfer unit 14 includes an intermediate transfer belt 16, four first transfer rollers 18Y, 18M, 18C, and 18K, and a second transfer roller 20.

The intermediate transfer belt 16 is an endless belt, and is wound upon a driving roller 26 and a support roller 22. The driving roller 26 is disposed so as to oppose the second transfer roller 20, and is driven by a driving unit such as a motor (not shown). The support roller 22 is rotatably supported. By driving and rotating the driving roller 26 by the driving unit such as a motor (not shown), the driving roller 26 rotates in the direction of arrow A (that is, in a counterclockwise direction in FIG. 1).

The first transfer rollers 18Y, 18M, 18C, and 18K are disposed at the inner side of the intermediate transfer belt 16. The first transfer rollers 18Y, 18M, 18C, and 18K are disposed so as to oppose photoconductor members 28, serving as exemplary exposure members to be exposed (described later) of the respective image forming units 12Y, 12M, 12C, and 12K, with the intermediate transfer belt 16 being disposed between the first transfer rollers 18Y, 18M, 18C, and 18K and the respective photoconductor drums 28. By applying a transfer voltage having a polarity that is opposite to a toner polarity to the first transfer rollers 18Y, 18M, 18C, and 18K, the toner images of the respective colors formed on the photoconductor members 28 are transferred to the intermediate transfer belt 16, and superposed upon each other.

By applying a transfer voltage having a polarity that is opposite to the toner polarity to the second transfer roller 20, the toner images of the respective colors superimposed upon each other on the intermediate transfer belt 16 are transferred to the recording paper P. A cleaning device (not shown) is provided at an outer peripheral surface of the intermediate transfer belt 16 where the support roller 22 is provided. The cleaning device removes, for example, residual toner or paper dust on the intermediate transfer belt 16.

A sheet feeding section 46 that holds recording paper P is provided below the image forming units 12. A sheet transport path S for transporting the recording paper P is provided upward in a perpendicular direction (that is, in the direction of arrow Z) from an end portion (that is, a right end portion in FIG. 1) of the sheet feeding section 46.

A delivery roller 48 that sends out the recording paper P from the sheet feeding section 46, a pair of transporting rollers 52 that transport the recording paper P, and a pair of positioning rollers 54 that match a timing of transporting the recording paper P and a timing of moving images on the intermediate transfer belt 16 are provided in the sheet transport path S.

Here, sheets of recording paper P that are successively sent out from the sheet feeding section 46 by the delivery roller 48 pass through the sheet transport path S, and are transported to a second transfer position of the intermediate transfer belt 16 by the positioning rollers 54.

A fixing device 60 is provided at a downstream side (that is, an upper side) of the second transfer roller 20 in the sheet transport path S. The fixing device 60 includes a heating roller 62 and a pressure roller 64. The heating roller 62 is heated by a heating source (such as a halogen heater) (not shown), and the pressure roller 64 presses the transferred toner images along with the heating roller 62 with the recording sheet P interposed between the heating roller 62 and the pressure roller 64.

A pair of discharge rollers 66 are provided at the downstream side of the fixing device 60 in the sheet transport path S. The discharge rollers 66 discharge the recording paper P to which the toner images are fixed to an outer side of the apparatus body 11. The recording paper P discharged by the discharge rollers 66 is discharged to a discharge section 67 formed at the upper surface of the apparatus body 11.

A controller 36 that controls each portion of the image forming apparatus 10 is provided in the apparatus body 11.

Next, the image forming units 12Y, 12M, 12C, and 12K will be described. Here, the toner colors are not distinguished.

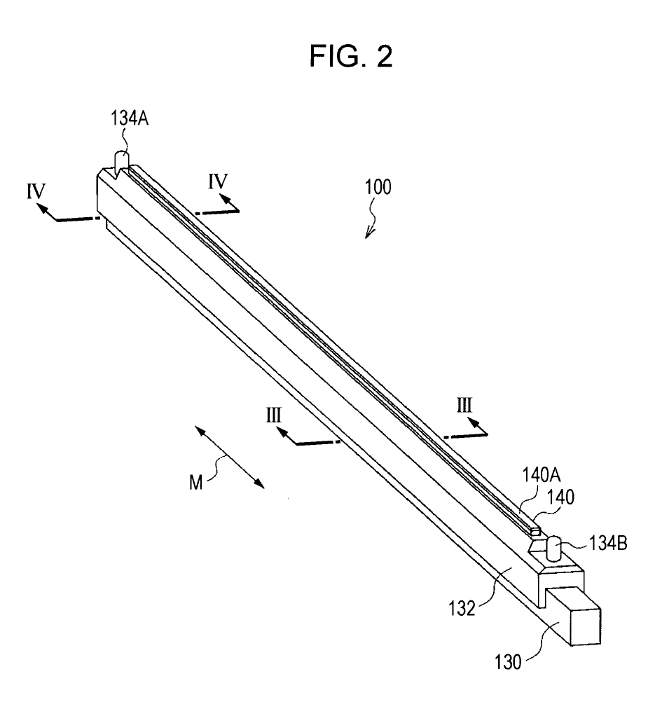

Each image forming unit 12 includes a drum-like photoconductor member 28, a charging roller 72, an exposure device 100 (see FIG. 2) (described in detail later), a developing roller 78, an erase lamp 74, and a cleaning blade 76. The photoconductor member 28 is rotationally driven in the direction of arrow B (that is, in an illustrated clockwise direction). The charging roller 72 contacts the outer peripheral surface of the photoconductor member 28, and charges the outer peripheral surface of the photoconductor member 28. The exposure device 100 irradiates the outer peripheral surface of the photoconductor member 28 with exposure light, and forms an electrostatic latent image on the outer peripheral surface of the photoconductor member 28. The developing roller 78 develops the electrostatic latent image on the outer peripheral surface of the photoconductor member 28 with toner. The erase lamp 74 irradiates with light the outer peripheral surface of the photoconductor member 28 to which the toner image is transferred, and removes electricity. The cleaning blade 76 cleans the outer peripheral surface of the photoconductor member 28 after removing the electricity.

The charging roller 72, an exposure unit 73, the developing roller 78, the erase lamp 74, and the cleaning blade 76 are disposed in that order so as to oppose the outer peripheral surface of the corresponding photoconductor member 28 from the upstream side to the downstream side in the direction of rotation of the corresponding photoconductor member 28. A cleaning roller 79 is rotatably provided at the outer peripheral surface of the corresponding charging roller 72 at a side opposite to the corresponding photoconductor member 28. The cleaning roller 79 removes, for example, an additive of toner that is adhered to the outer peripheral surface of the corresponding charging roller 72. The charging roller 72 is connected to an electrifying unit (not shown). While the charging roller 72 is driven and rotated, electricity is applied to the charging roller 72 when forming images, so that the outer peripheral surface of the corresponding photoconductor member 28 is charged.

Two spiral transport members 81 that stir (mix) a developer (such as a mixture of resinous toner and a metallic carrier) supplied from a toner supplying section (not shown) are provided below each developing roller 78. A thin-film formation roller 97 is provided so as to oppose the outer peripheral surface of its corresponding developing roller 78. At a side that is upstream from the photoconductor member 28 in the direction of rotation of the developing roller 78, the corresponding thin-film formation roller 97 is disposed so as to be spaced apart from the outer peripheral surface of the corresponding developing roller 78. The thin-film formation roller 97 restricts the amount of passage of the developer on the outer peripheral surface of the corresponding developing roller 78, to form a developer layer (thin layer) having a predetermined thickness on the corresponding developing roller 78.

Each developing roller 78 includes a fixed magnet roller (not shown) and a cylindrical developing sleeve (not shown), rotatably provided at the outer side of the magnet roller. A voltage is applied between the developing roller 78 and the corresponding photoconductor member 28 during development, so that an electrical field is formed. Each developing roller 78 moves the toner in the developer towards the electrostatic latent image on the corresponding photoconductor member 28 while each developing roller 78 rotates.

Next, the process of forming images by the image forming apparatus 10 will be described.

As shown in FIG. 1, when the units of the image forming apparatus 10 are in an operating state, items of image data to which image processing is performed by the controller 36 are converted into items of colorant gradation data for the respective colors. The items of colorant gradation data are successively output to the respective exposure devices 100Y, 100M, 100C, and 100K (refer to FIG. 2) (details discussed later). In the exposure devices 100, exposure lights L (see FIG. 3) corresponding to the items of colorant gradation data for the respective colors are emitted, and exposure operations are performed on the outer peripheral surfaces of the respective photoconductor members 28 charged by the respective charging rollers 72, so that electrostatic latent images are formed on the respective photoconductor members 28.

The electrostatic latent images formed on the respective photoconductor members 28 are developed into toner images (developer images) of the respective colors, yellow (Y), magenta (M), cyan (C), and black (K), by the developing rollers 78. The toner images of the respective colors that are formed successively on the photoconductor members 28 of the respective image forming units 12Y, 12M, 12C, and 12K are successively transferred by a multi-layer transfer operation onto the intermediate transfer belt 16 by the four first transfer rollers 18Y, 18M, 18C, and 18K.

The toner images of the respective colors that are transferred to the intermediate transfer belt 16 by the multi-layer transfer operation are transferred by the second transfer roller 20 by a second transfer operation to recording paper P transported from the sheet feeding section 46. The toner images of the respective colors on the recording paper P are fixed by the heating roller 62 and the pressure roller 64 at the fixing unit 60. The recording paper P after the fixing is discharged to the discharge section 67 by the discharge rollers 66. The cleaning blades 76 remove, for example, any residual toner or paper dust from the outer peripheral surfaces of the photoconductor members 28 after the first transfer of the toner images is completed.

Next, the exposure devices 100Y, 100M, 100C, and 100K will be described without distinguishing between the toner colors.

As shown in FIG. 2, each exposure device 100 is what is called a LED print head (LPH) that is long. As shown in FIG. 1, the exposure devices 100 are disposed below the photoconductor members 28 with directions of rotational axes of the photoconductor members 28 (the directions of a double-headed arrow M in FIG. 2) being longitudinal directions. The exposure devices 100 expose the photoconductor members 28 from below the photoconductor members 28. In addition, the exposure devices 100 are removable from the apparatus body 11.

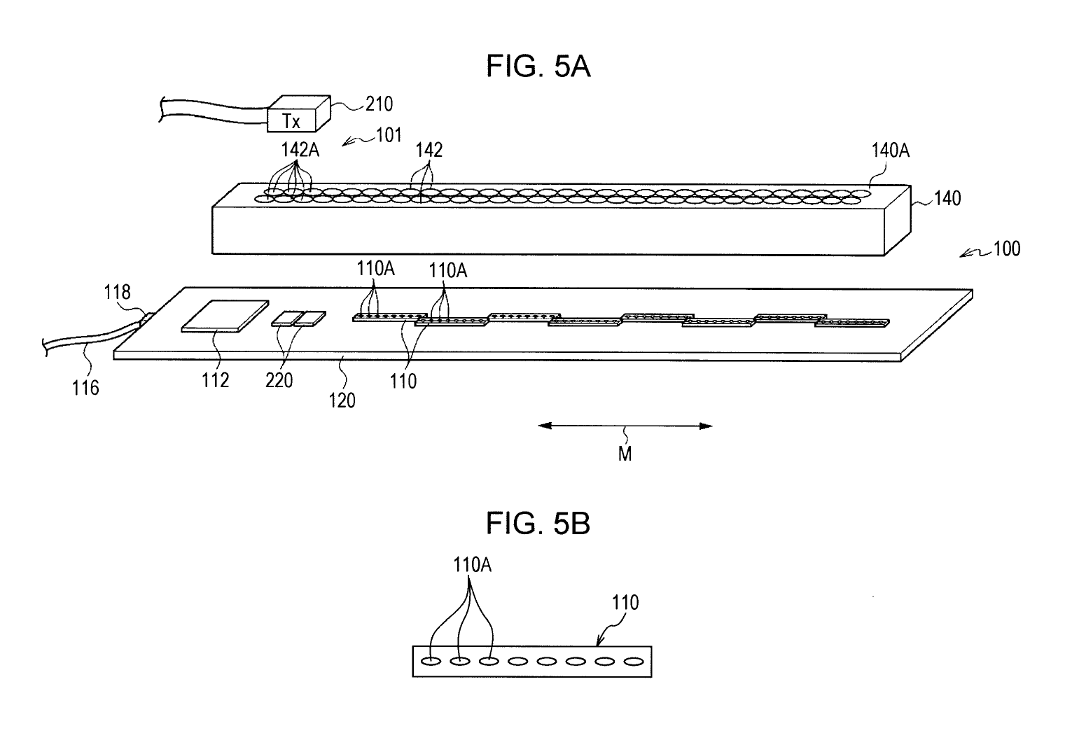

As shown in FIG. 5A, the exposure device 100 includes a substrate 120 where light-emitting-element chips 110 having light-emitting elements 110A disposed in a row are provided. The light-emitting-element chips 110 are alternately disposed in a staggered arrangement so that, at boundaries of end portions in the arrangement of the light-emitting elements (LEDs) 110A, the light-emitting elements 110A are continuously disposed at connection portions of the light-emitting-element chips 110. In the exemplary embodiment, each light-emitting element 110A is a light-emitting diode (LED), and each light-emitting-element chip 110 is a LED chip.

For example, a driving circuit 112 that drives the light-emitting-element chips 110 (light emitting elements 110A) and optical-signal receiving sections 220 (also refer to FIG. 4) are provided on the substrate 120.

As shown in FIGS. 2 and 3, the substrate 120 is secured to a housing 130. In the exemplary embodiment, the housing 130 is formed of a sheet metal or a metallic block formed of, for example, aluminum or SUS.

As shown in FIGS. 2 to 5A, a lens array 140 is what is called a SELFOC (trademark) lens array (SLA) in which graded index lenses (SELFOC (trademark) lenses) 142 (see FIG. 5A) are disposed in rows. The graded index lenses 142 form erected real image having a 1×-magnification.

A holder 132 secures the lens array 140 and the housing 130, to which the substrate 120 is secured, so that light-emission points of the light-emitting elements (LEDs) 110A and a focal plane of the lens array 140 match.

The optical-signal receiving sections 220 including photodetectors, such as photodiodes, are provided at an end portion of the substrate 120 in the longitudinal directions (that is, the directions of the double-headed arrow M). Although, in the exemplary embodiment, two optical-signal receiving sections 220 are provided, the number of optical-signal receiving sections 220 is not limited thereto. One optical-signal receiving section 220 or three or more optical-signal receiving sections 220 may be used.

The optical-signal receiving sections 220 receive optical signals S (see FIG. 4), emitted from an optical-signal sending-out section 210 (described later), through the lens array 140 (the graded index lenses 142), and convert the optical signals S into electrical signals.

A power-supply line 116 that supplies electrical power from a power supply to each exposure device 100 is electrically connected by a connector 118 provided at an end surface in the longitudinal direction of the substrate 120.

As shown in FIG. 2, positioning pins 134A and 134B are provided near respective ends in the longitudinal directions (the directions of the double-headed arrow M) of the holder 132 of the exposure device 100.

When the exposure devices 100 are mounted to the apparatus body 11, the exposure devices 100 are urged by urging units (not shown), such as springs, in a direction in which the positioning pins 134A and 134B protrude. When ends of the respective positioning pins 134A and 134B strike positioning members of the apparatus body 11, a distance R1 (see FIG. 3) between an outer peripheral surface (light receiving surface) 28A of the corresponding photoconductor member 28 and the corresponding exposure device 100 becomes a focal length. That is, the exposure devices 10 are positioned with respect to and secured to the apparatus body 11 so that the outer peripheral surfaces (light receiving surfaces) 28A of the photoconductor members 28 become focus positions.

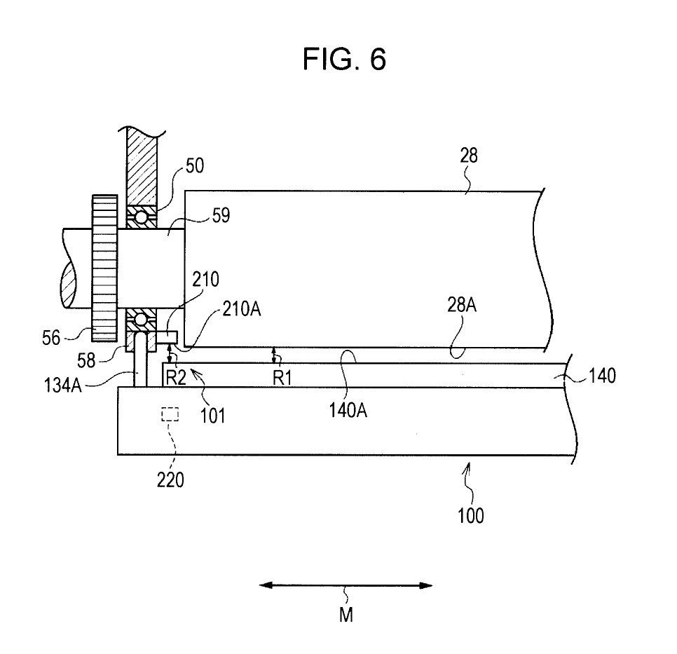

As shown in FIG. 6, in the exemplary embodiment, when the positioning pins 134A and 134B strike bearings 50 at the respective ends of a rotary shaft 59 of its corresponding photoconductor member 28, the corresponding exposure device 100 is positioned so that the distance R1 (see FIG. 3) between the outer peripheral surface 28A of the corresponding photoconductor member 28 and an exposure surface 140A of the lens array 140 of the corresponding exposure device 100 becomes a focal length. Although FIG. 6 only shows a drive side of the photoconductor member 28, the opposite side thereof has the same structure.

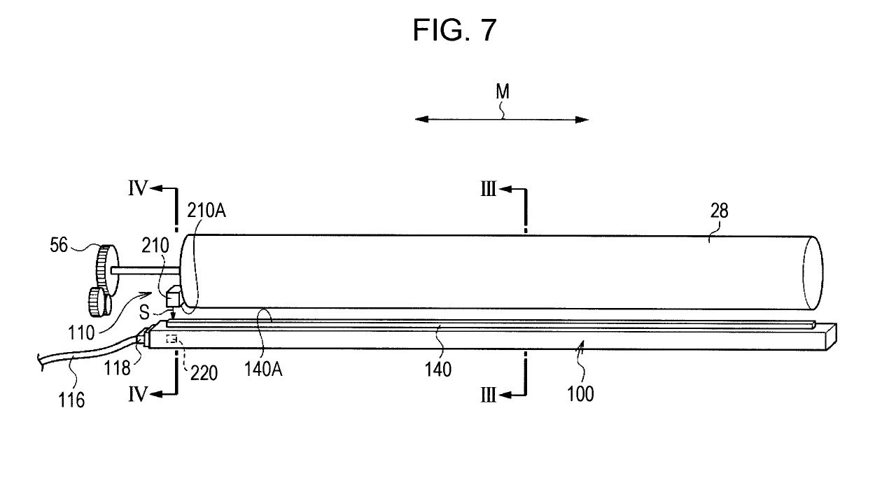

As shown in FIG. 6, each bearing 50 is provided at a housing 58. The optical-signal sending-out section 210 that emits the optical signals S is secured to the housing 58 at a side where a driving gear 56 that drives the photoconductor member 28 is provided (also see FIG. 7).

As shown in FIG. 4, a distance R2 between a light-emitting surface 210A of the corresponding optical-signal sending-out section 210 and the exposure surface 140A of the corresponding exposure device 100 is fixed between positions that are the same or substantially the same as those determining the distance R1 between the outer peripheral surface 28A of the corresponding photoconductor member 28 and the exposure surface 140A of the corresponding exposure device 100. In other words, the light-emitting surface 210A of the optical-signal sending-out section 20 is fixed at or near the focus position (focal position) of the lens array 140.

As mentioned above, the items of image data subjected to the image processing at the controller 36 (see FIG. 1) are converted into the items of colorant gradation data for the respective colors, and the items of colorant gradation data are successively output to the respective exposure devices 100. In the exposure devices 100, the exposure lights L (see FIG. 3) corresponding to the items of colorant gradation data for the respective colors are emitted, and the exposure operations are performed on the outer peripheral surfaces of the respective photoconductor members 28 charged by the respective charging rollers 72, so that electrostatic latent images are formed on the respective photoconductor members 28.

Here, in the exemplary embodiment, as shown in, for example, FIG. 7, the items of image data that are sent as electrical signals from the controller 36 are transmitted to the exposure devices 100 by signal transmission structures 101 provided at end portions of the respective exposure devices 100, each including the optical-signal sending-out section 210 and the optical-signal receiving section 220.

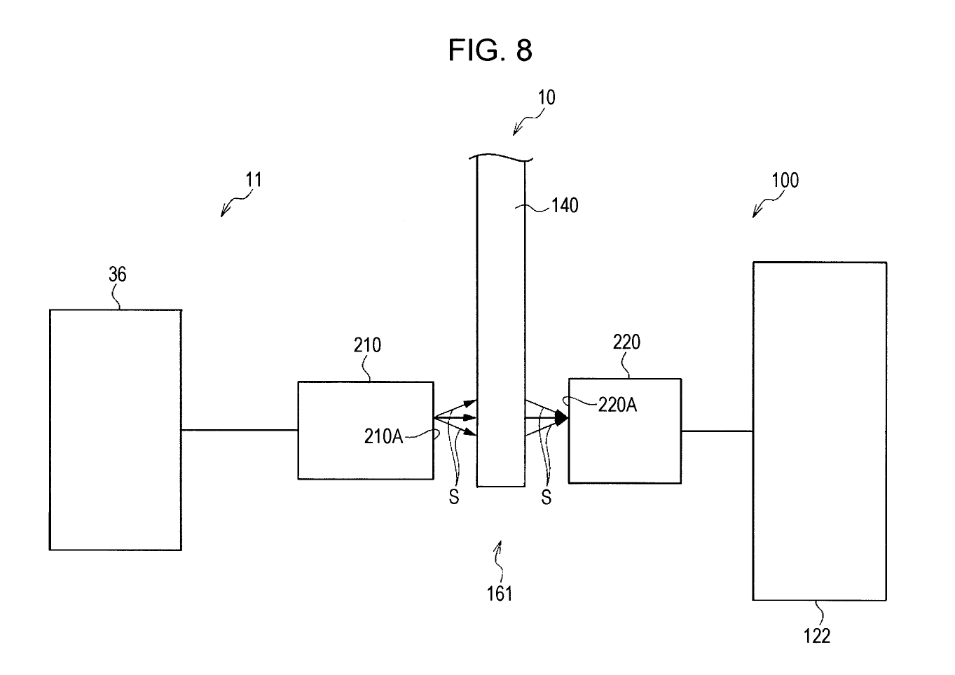

That is, as shown in FIGS. 4 and 8, the items of image data that are sent as electrical signals from the controller 36 are such that the electrical signals are converted into optical signals by the optical-signal sending-out sections 210, and are emitted from the optical-signal sending-out sections 210 as the optical signals S.

The optical signals S emitted from the corresponding optical-signal sending-out section 210 pass through the corresponding lens array 140 (graded index lenses 142), so that the optical signals S are focused at and received by a light-receiving surface 220A of the corresponding optical-signal receiving section 220. The optical-signal receiving section 220 re-converts the optical signals S into electrical signals, and transmits the electrical signals to the driving circuit 122.

In the exemplary embodiment, as shown in FIG. 5, the optical-signal receiving section 220 of each exposure device 100 receives the optical signals S through the graded index lenses 142A disposed at an end portion in a row direction that is not used for the exposure of the photoconductor member 28.

Next, the operation and advantages of the exemplary embodiment will be described.

The optical-signal receiving section 220 of each exposure device 100 receives the optical signals S through the graded index lenses 142A. Therefore, it is not necessary to separately and newly provide optical components or optical mechanisms, and the signals are transmitted to the exposure devices 100 without contacting the exposure devices 100 by optical communication. Therefore, compared to a structure in which signals are transmitted using electrical signals, it is possible to prevent improper transmission of the signals caused by, for example, contact failure of a connector, as a result of which the signals are transmitted with greater reliability.

Since the graded index lenses 142 form erected real images having a 1×-magnification, when the optical signals S emitted from an exposure-side focus position or from the vicinity thereof are incident from each exposure surface 140A, the optical signals S are focused at the corresponding optical-signal receiving section 220. That is, when the optical-signal receiving sections 220 are provided at the corresponding substrates 120 where the exposure light-emitting-element chips 110 (light-emitting elements 110A) are provided, the optical signals that are incident from the exposure side are focused at the corresponding optical-signal receiving sections 220. Therefore, it is not necessary to provide, for example, precise positioning mechanisms for the optical-signal receiving sections 220.

The optical-signal receiving section 220 of each exposure device 100 receives the optical signals S through the graded index lenses 142A disposed at the end portion in the row direction that is not used for the exposure of the photoconductor member 28.

Compared to a structure in which the optical signals S are received only through the graded index lenses 142 used in performing exposure of the photoconductor members 28, it is possible to dispose the optical-signal sending-out sections 210 with greater freedom in terms of design and to dispose the optical-signal receiving sections 220 on the substrate 120 with greater freedom in terms of design.

By using optical communication in a signal line by applying the present invention, it is possible to easily use the high-capacity connectors 210 having high contact reliability and used specially for power sources. As a result, a voltage variation of a power line, which is factor that causes a variation in the light quantity of each exposure light-emitting element 110A, is reduced compared to that in a structure in which a signal line and a power line are connected using the same connector.

The present invention is not limited to the above-described exemplary embodiments. Various modes may be carried out without departing from the gist of the present invention.

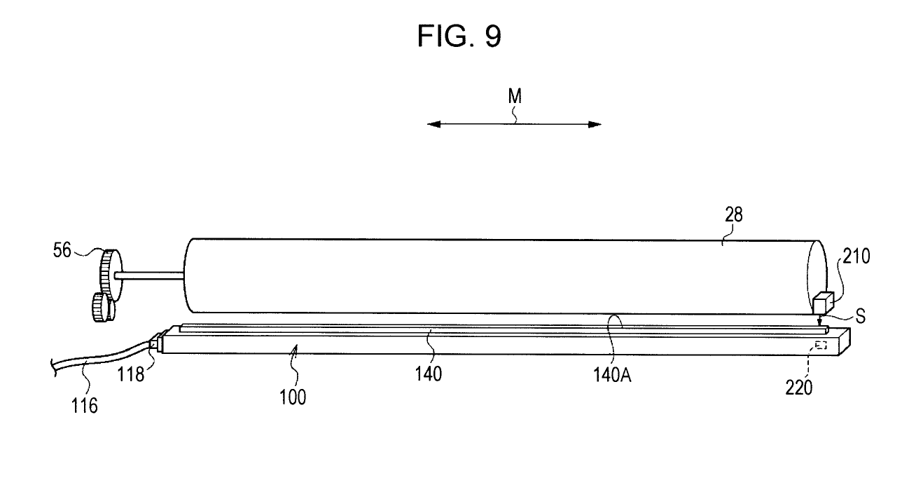

For example, although, as shown in FIG. 7, each optical-signal sending-out section 210 and each optical-signal receiving section 220 are provided at the end portion in the direction of the double-headed arrow M at the side where the corresponding driving gear 56 that drives the corresponding photoconductor member 28 is provided, the present invention is not limited thereto. For example, as shown in FIG. 9, each optical-signal sending-out section 210 and each optical-signal receiving section 220 may be provided at an end portion in the direction of a double-headed arrow M at a side that is opposite to the side where the corresponding driving gear 56 that drives the corresponding photoconductor member 28 is provided.

For example, although, in the exemplary embodiment, each optical-signal receiving section 220 is formed so as to receive the optical signals S only through the graded index lenses 142A disposed at the end portion in the row direction (direction of the double-headed arrow M) that is not used for the exposure of the photoconductor member 28, the present invention is not limited thereto.

The optical-signal receiving sections 220 may be formed so as to receive the optical signals S through the graded index lenses 142 that are used for exposure of the photoconductor members 28.

Although, in the exemplary embodiments, the exposure device to which the present invention is applied is used in the image forming apparatus, the present invention is not limited thereto. The present invention is applicable to apparatuses other than the image forming apparatus.

What is claimed is:

1. An exposure device comprising:
a substrate on which a plurality of exposure light-emitting elements are disposed in a row;
an optical component that is formed integrally with the substrate, the optical component being provided with a plurality of graded index lenses, the optical component causing exposure light emitted from the plurality of exposure light-emitting elements to be focused on an exposure member to be exposed; and
a receiving section that is provided at the substrate, the receiving section receiving an optical signal through the graded index lenses and converting the received optical signal into an electrical signal, the optical signal being emitted from a light-emitting section provided at a side of the exposure member to be exposed.

2. The exposure device according to claim 1, wherein the receiving section is provided at an outer side in a row direction with respect to the plurality of exposure light-emitting elements, and
wherein the receiving section receives the optical signal through one or more of the graded index lenses disposed at an end portion in the row direction that is not used for exposure of the exposure member to be exposed.

3. A signal transmission mechanism for an exposure device, the signal transmission mechanism comprising:
the exposure device that includes a substrate, an optical component, and a receiving section, the substrate having a plurality of exposure light-emitting elements disposed thereon in a row, the optical component being formed integrally with the substrate, the optical component being provided with a plurality of graded index lenses, the optical component causing exposure light emitted from the plurality of exposure light-emitting elements to be focused on an exposure member to be exposed, the receiving section being disposed at the substrate and converting an optical signal received through the graded index lenses into an electrical signal; and
a light-emitting section that is provided at a side of the exposure member to be exposed and that emits the optical signal to be received by the receiving section through the graded index lenses.

4. The signal transmission mechanism according to claim 3, wherein the receiving section of the exposure device is provided at an outer side in a row direction with respect to the plurality of exposure light-emitting elements, and
wherein the receiving section of the exposure device receives the optical signal through one or more of the graded index lenses disposed at an end portion in the row direction that is not used for exposure of the exposure member to be exposed.

5. An image forming apparatus comprising:
a rotating image carrying member that is mounted to an apparatus body;
an exposure device that is mounted to the apparatus body and that includes a substrate, an optical component, and a receiving section, the substrate having a plurality of exposure light-emitting elements disposed thereon in a row along a direction of a rotational axis of the image carrying member, the optical component formed integrally with the substrate, the optical component being provided with a plurality of graded index lenses, the optical component causing exposure light emitted from the plurality of exposure light-emitting elements to be focused on the image carrying member, the receiving section being provided at the substrate and converting an optical signal received through the graded index lenses into an electrical signal; and
a light-emitting section that is provided at a side of the image carrying member at the apparatus body and that emits the optical signal to be received by the receiving section through the graded index lenses.

6. The image forming apparatus according to claim 5, wherein the receiving section of the exposure device is provided at an outer side in a row direction with respect to the plurality of exposure light-emitting elements, and
wherein the receiving section of the exposure device receives the optical signal through one or more of the graded index lenses disposed at an end portion in the row direction that is not used for exposure of an exposure member to be exposed.
